(19) United States
(12) Patent Application Publication
(10) Pub. No.: US 2021/0020346 A1
(43) Pub. Date: Jan. 21, 2021

(54) Method for Operating a Cooling System of a Transformer

(71) Applicant: Siemens Aktiengesellschaft, Muenchen (DE)

(72) Inventors: Mario Scala, Graz (AT); Florian Bachinger, St. Georgen/Gusen (AT)

(21) Appl. No.: 16/928,095

(22) Filed: Jul. 14, 2020

(30) Foreign Application Priority Data
Jul. 17, 2019 (EP) 19186821

(51) Int. Cl. H01F 27/12; H01F 27/02; G06F 1/3296

(52) U.S. Cl. CPC H01F 27/125; G06F 1/3296; H01F 27/025

(57) ABSTRACT

A method for operating a cooling system of a transformer, wherein the transformer is cooled via a cooling liquid that circulates in the cooling system that includes a heat-exchanger, devices for increasing heat exchange performance of the at heat-exchanger and a controller, where in a normal operating state, the controller adjusts power of the devices for increasing the heat exchange performance as a function of a measured upper temperature and where, irrespective of the measured upper temperature, the controller refrains from activating the devices and/or operates the devices at a reduced power relative to the normal operating state if the lower temperature of the cooling liquid lies below a lower threshold value during operation of the transformer to achieve improved characteristics of the cooling system during operation under low environmental temperatures of the transformer, particularly in the case of a turn-on operation following lengthy storage in a cold state.

### BACKGROUND OF THE INVENTION

### 1. Field of the Invention

The invention relates to a control device, a transformer, a computer program product and a method for operating a cooling system of a transformer, preferably a power transformer or a reactor, having at least one transformer winding, wherein a cooling liquid of the cooling system surrounds the at least one transformer winding and a transformer core if applicable, and the cooling liquid circulates in the cooling system in a normal operating state of the transformer, wherein at least the heat produced in the at least one transformer winding is released into a surrounding atmosphere by means of the circulating cooling liquid, where the cooling system comprises at least one heat-exchanger unit through which the cooling liquid can flow, for the release of heat from the cooling liquid into the surrounding atmosphere, means for increasing a heat exchange performance of the at least one heat-exchanger unit, said means interacting with the at least one heat-exchanger unit, a control unit for adjusting the heat exchange performance of the at least one heat-exchanger unit, and where an upper temperature Tₒ is measured in the cooling system and/or at the transformer and, in a normal operating state, the control unit adjusts a power of the means for increasing the heat exchange performance of the at least one heat-exchanger unit as a function of the measured upper temperature Tₒ.

### 2. Description of the Related Art

The transformer windings, also referred to as coils, of a transformer consist of closely wound wires, where heat is produced in the interior of these windings in an operating state of the transformer. Transformers comprising only one transformer winding that is designed as a main winding can function as reactors or reactance coils, for example. If the transformer has at least two transformer windings, an input voltage can be transformed into an output voltage via the transformer. Transformers usually also have at least one transformer core, which can likewise represent a heat source.

In order to prevent build-up of heat inside the transformer, provision is made for a cooling system in which a cooling liquid circulates in order to transfer heat away in a normal operating state, such that the heat from the transformer, i.e., from the transformer windings and if applicable from the transformer core, is released into the environment or the surrounding atmosphere. The normal operating state is primarily characterized in that current flows through the transformer and circulation of a significant part of the cooling liquid in the cooling system has started. Here, the circulation of the cooling liquid can either occurs passively due to convection or can be assisted or driven by pump units, such as cooling-liquid pumps. The cooling liquid usually also serves as an electrical insulating medium.

In this case, the cooling system of the transformer usually comprises at least one heat-exchanger unit, through which the cooling liquid flows in the normal operating state. Heat from the cooling liquid is released into the surrounding atmosphere via the at least one heat-exchanger unit. In order to be able to increase the heat exchange performance and possibly reduce the heat-releasing surface area of the heat-exchanger unit, devices are usually provided for increasing the heat exchange performance of the at least one heat-exchanger unit, said means interacting with the respective heat-exchanger unit. The device for increasing the heat exchange performance can comprise one or more ventilator units that generate an airstream that is directed at the heat-exchanger unit, where use is preferably made of axial ventilators in which the rotational axis of an impeller of the ventilator unit extends parallel to or axially in relation to an airstream. The devices for increasing the heat exchange performance can also comprise pump units that transport the cooling liquid through the heat-exchanger unit. A combination of pump unit(s) and ventilator unit(s) is also possible. With the devices for increasing the heat exchange performance, the heat release of the cooling liquid in the heat-exchanger unit can be improved or, in other words, the cooling of the cooling liquid in the heat-exchanger unit can be enhanced such that the cooling liquid is cooled more effectively and/or quickly.

In order to adjust the required cooling power in the normal operating state of the transformer, in particular the power of the devices for increasing the heat exchange performance, provision is made for a control device in the prior art. Here, an input signal of the control device is an upper temperature Tₒ measured in the transformer or in the cooling system, where the upper temperature can be, e.g., an upper temperature of the cooling liquid, in particular at the input of the first heat-exchanger unit or in the upper region of the transformer, preferably a hot-oil temperature, and/or a core temperature of the transformer and/or temperatures measured in the at least one transformer winding, e.g., for the purpose of identifying hotspots. If it is established that a predefined first upper threshold value has been exceeded by the measured upper temperature Tₒ, for example, the control device can activate a ventilator unit and/or a pump unit or increase the power of the ventilator unit and/or the pump unit in order to increase the heat exchange performance of the heat-exchanger unit or to improve the transfer of heat away from the heated regions of the transformer to the heat-exchanger unit.

While the dependency of the power of the devices for increasing the heat exchange performance on the measured upper temperature Tₒ must be considered advantageous in many operating states, operating states are nonetheless possible in which such an adjustment results in significant disadvantages. For example, in the case of low environmental temperatures and consequently a low operating temperature, particularly in a start-up phase (i.e., in the context of activation or running up) of the transformer from a cold state, it can occur that only part of the cooling liquid that has become semi-fluid due to the environmental temperature heats up as a result of the heat produced in the transformer and, by virtue of its temperature-dependent lower viscosity, circulates or begins to circulate. Here, the already heated circulating cooling liquid can result in a high measured upper temperature Tₒ, because a majority of the cooling liquid does not yet circulate in the outer cooling circuit due to the low temperature and therefore does not contribute or contributes only very slightly to transferring heat away. Here, an activation of the devices for increasing the heat exchange performance or an increase in the power of the device for increasing the heat exchange performance must be considered disadvantageous, because the additional cooling of the cooling liquid flowing through the at least one heat-exchanger unit prevents the removal of heat from the interior of the transformer. As a result of only a small part of the cooling liquid circulating, overheating of the transformer can occur in spite of the active cooling in the at least one heat-exchanger unit, because the heat produced in the transformer cannot be transferred away by the circulating part of the cooling liquid. Moreover, a situation can arise in which the high viscosity of the cooling liquid due to the low temperature results in no flow or inadequate flow through the at least one heat-exchanger unit, also known as “freezing” of the heat-exchanger unit, such that the additional cooling of the heat-exchanger unit prevents the heat-exchanger unit from “defrosting”. A cold start is understood in particular to mean a turn-on operation of the transformer following lengthy storage in a cold state under low environmental temperatures.

### SUMMARY OF THE INVENTION

In view of the foregoing, it is therefore an object of the invention to provide a method for adjusting the cooling system of a transformer, where the method overcomes the disadvantages of the conventional systems and achieves an improved characteristic of the cooling system under low environmental temperatures, particularly in a start-up phase from a cold state.

It is also an object of the invention to effect advance cooling before a high load current results in high temperatures, if the cold conditions no longer apply.

These and other objects and advantages are achieved in accordance with the invention by a method for operating a cooling system of a transformer, preferably a power transformer or a reactor, having at least one transformer winding, wherein a cooling liquid of the cooling system surrounds the at least one transformer winding and a transformer core if applicable, and the cooling liquid circulates in the cooling system in a normal operating state of the transformer, where at least the heat produced in the at least one transformer winding is released into the surrounding atmosphere via the circulating cooling liquid, where the cooling system comprises at least one heat-exchanger unit through which the cooling liquid can flow, for the release of heat from the cooling liquid into the surrounding atmosphere, devices for increasing a heat exchange performance of the at least one heat-exchanger unit, where the devices interact with the at least one heat-exchanger unit, a control unit for adjusting the heat exchange performance of the at least one heat-exchanger unit, where an upper temperature Tₒ is measured in the cooling system and/or at the transformer and, in a normal operating state, the control unit adjusts a power of the devices for increases the heat exchange performance of the at least one heat-exchanger unit as a function of the measured upper temperature Tₒ.

The objects of the invention are achieved by virtue of the fact that a lower temperature Tᵤ of the cooling liquid is measured in the cooling system and, irrespective of the measured upper temperature Tₒ, the control unit does not activate the device for increasing the heat exchange performance of the at least one heat-exchanger unit and/or operates the means for increasing the heat exchange performance of the at least one heat-exchanger unit at a reduced power relative to the normal operating state if the lower temperature Tᵤ of the cooling liquid lies below a lower threshold value Sᵤ during the operation of the transformer. As a result of the temperature level of the cooling liquid being equalized more quickly due to the reduction or absence of additional cooling by the devices for increasing the heat exchange performance, the period before the totality of the cooling liquid circulates in the cooling system is shortened and therefore the danger of overheating the transformer in the context of a cold start can be drastically reduced. The same applies to the case in which the transformer is operated at low power under low environmental temperatures, such that a low operating temperature occurs, and the transformer is run up from this state.

By virtue of the inventive capture of the lower temperature Tᵤ of the cooling liquid and the comparison of the measured lower temperature with a lower threshold value Sᵤ, this usually being predefined and dependent on the cooling liquid or the transformer design, it is largely possible to operate the control device in an optimal manner, even when running up under low environmental temperatures, because a low operating temperature and/or a so-called cold start, i.e., a turn-on operation following lengthy storage in a cold state under low environmental temperatures, can be identified by the control device and taken into consideration accordingly during the adjustment. In this case, it should be understood that the control device can also perform adjustment-related tasks as a result of taking an adjustment variable into consideration. As a result of the deactivation or reduction in the power or cooling power of the devices for increasing the heat exchange performance, the cooling power of the at least one heat-exchanger unit is reduced, such that the cooling liquid leaves the heat-exchanger unit and enters the transformer at a higher temperature than in the normal operating state, such that the remaining cooling liquid which is at a lower temperature level heats up more quickly, where the remaining cooling liquid is preferably situated in a housing. This means that regions of the cooling liquid with extremely high viscosity can be reduced and circulation of as far as possible the totality of the cooling liquid in the cooling system can be achieved more quickly. As soon as the measured lower temperature Tᵤ reaches the lower threshold value Sᵤ or exceeds the lower threshold value Sᵤ by a predefined amount, e.g., 5° C., 10° C. or 15° C., preferably at least 20° C., or an intermediate value, the control device can be switched over to the conventional adjustment of the devices for increasing the heat exchange performance as a function of the measured upper temperature, or the devices for increasing the heat exchange performance can be activated for this purpose.

If the devices for increasing the heat exchange performance comprise at least one ventilator unit, the cooling power can be influenced either by reducing the rotational speed or by deactivating individual ventilator units, in particular individual cooling stages. If the devices for increasing the heat exchange performance comprise at least one pump unit, the cooling power can be influenced either by reducing the pumping power or by deactivating individual pump units, in particular individual cooling stages. It should be understood, it is also possible to control or adjust pump units and ventilator units at the same time.

In an embodiment of the invention, the devices for increasing the heat exchange performance of the at least one heat-exchanger unit comprise at least one ventilator unit and/or at least one pump unit that transports the cooling liquid through the at least one heat-exchanger unit in the normal operating state. Depending on the required maximum cooling power and/or the transformer design, e.g. ODAN, ODAF, OFAF or ONAF cooling stages can be realized accordingly.

In an embodiment of the invention, the transformer is arranged inside a housing that is filled with the cooling liquid and the heat-exchanger unit is arranged in a cooling circuit that is fluidically connected to the housing, where the cooling liquid circulates through the cooling circuit in the normal operating state. The housing that contains the cooling liquid and surrounds the transformer, also referred to as a boiler, usually functions as a primary heat exchanger, such that heat can be absorbed from the cooling liquid and released into the environment via the housing, particularly if there is little circulation of the cooling liquid within the cooling system. As a result of linking the at least one heat-exchanger unit to the housing by via the cooling circuit, heat can be released into the environment in an efficient manner and the at least one heat-exchanger unit can be arranged outside the housing. In this case, it is advantageous for each heat-exchanger unit to have an inlet that is fluidically connected to the housing for cooling liquid that has a high temperature and an outlet for cooling liquid that has been cooled by the heat-exchanger unit. If a plurality of heat-exchanger units are provided, these can be connected in parallel with each other, for example.

In order to obtain a value that is as meaningful as possible when capturing the lower temperature Tᵤ, via which value it is possible in the control device to detect as reliably as possible a cold start under low environmental temperatures and correspondingly low operating temperatures, in a further embodiment of the invention the lower temperature Tᵤ of the cooling liquid is measured in that region of the cooling system, preferably in that region of the housing, in which the lowest temperature of the cooling liquid is to be expected. The lower temperature is preferably measured via a temperature sensor arranged in that region. The regions of the cooling system in which the lowest temperatures of the cooling liquid prevail usually form in the region of the heat-exchanger unit itself or in the interior of the housing in the region below the transformer windings, where the cooling liquid that has been cooled by the heat-exchanger unit usually flows back into the housing in order to cool the at least one transformer winding, i.e., in the floor region of the housing, because few heat sources are present in these regions and it is only by virtue of the flow through the heat sources, from the bottom upwards, that the heat energy is transferred from the heat sources, in particular from the at least one transformer winding or the transformer core, to the cooling liquid in the form of heat. Therefore, regions that are situated further down are heated up less quickly. Likewise, colder cooling liquid sinks due to its higher density and higher viscosity. The exact temperature distribution in the different regions of the transformer is dependent on the design of the transformer, in particular on the layout of the housing and the supply of the cooling liquid to the heat sources or the transformer windings. As a result of capturing the lower temperature of the cooling liquid in the region of the lowest expected temperature of the cooling liquid, it is moreover possible to ensure that the cooling power of the heat-exchanger unit is only increased by the devices for increasing the heat exchange performance if the temperature of the cooling liquid in the corresponding region of the cooling system, preferably in the entire cooling system, lies above the lower threshold value Sᵤ.

In a further embodiment, the lower temperature Tᵤ is measured via a first temperature sensor, where the first temperature sensor is arranged in a floor region of the housing and/or in the region of the junction of an outlet of the cooling circuit into the housing. As experience teaches, the floor region of the housing of the transformer or the region of the housing in which the cooling liquid that has been cooled in the cooling circuit returns into the housing via the outlet, represents the region in which the lowest temperature of the cooling liquid is to be expected, because large volumes of cooling liquid in solid or semi-fluid that form here can slow down the heating, and no heat sources or weak heat sources are present. It is naturally conceivable that more than one temperature sensor can also be provided, in order to capture the lowest liquid temperature or various low temperatures, and thereby allow the lower temperature Tᵤ to be determined more accurately. For example, two, three or four temperature sensors can be provided, where the lower temperature Tᵤ can be defined as a minimum value or as an average value of the different measured values.

In according with a further embodiment of the inventive method, the devices for increasing the heat exchange performance of the at least one heat-exchanger unit comprise at least one pump unit that transports the cooling liquid through the at least one heat-exchanger unit in the normal operating state, where the at least one pump unit is activated by the control unit if the lower temperature Tᵤ of the cooling liquid during the operation of the transformer lies below the lower threshold value Sᵤ and above a lower limit temperature Gᵤ. As a result of the activation of the at least one pump unit by the control device when a critical cold characteristic is detected based on the measured lower temperature Tᵤ, a better flow of the cooling liquid in the cold regions of the cooling system, in particular in the at least one heat-exchanger unit, is effected by the pump pressure than by the natural thermosiphonic effect that is produced solely by the heating of the cooling liquid by the heat sources, in particular the transformer windings. Moreover, the heat released in the pump unit is beneficial for the heating process of the cooling liquid. The at least one pump unit can assist the circulation of the cooling liquid through the at least one heat-exchanger unit and/or through the cooling circuit in the normal operating state. It is moreover conceivable for the power of the at least one pump unit to be adjusted as a function of the measured upper temperature Tₒ and/or lower temperature Tᵤ in order to improve the intermixture. Concerning the lower limit temperature Gᵤ, reference is made to the following paragraph for the sake of clarity.

Depending on the type of cooling liquids in the transformer, there are operating temperatures at which the continuous operation of pump units is not possible or not desirable. For example, this applies in the case of low operating temperatures at which the viscosity of the cooling liquid is so high that, owing to the lack of circulation of the cooling liquid through the pump unit, the pump unit would not be sufficiently cooled and the pump unit would therefore be deactivated at least temporarily by the motor protection. The temperature at which the cooling liquid exhibits this characteristic is subsequently referred to as lower limit temperature Gᵤ, which lies below the lower threshold value Sᵤ. For example, the lower limit value or the lower limit temperature Gᵤ can be the congealing temperature of the cooling liquid.

In a further embodiment of the invention, the devices for increasing the heat exchange performance of the at least one heat-exchanger unit comprise at least one pump unit that transports the cooling liquid through the at least one heat-exchanger unit in the normal operating state, where the at least one pump unit is periodically activated and deactivated by the control unit if the lower temperature Tᵤ of the cooling liquid during the operation of the transformer lies below a lower limit temperature Gᵤ, where the lower limit temperature Gᵤ is lower than the lower threshold value Sᵤ. As a result of the periodical operation, during which the activated and deactivated time segments alternate, the overheating of the at least one pump can be prevented via the deactivation and the heat that is released by the operation of the at least one pump unit can assist the heating process of the cooling liquid. In this case, it is advantageous if the activated time and deactivated time are of approximately equal length, where various distributions between 75% active time and 25% deactivated time, or 25% activate time and 75% deactivated time are also conceivable. The active time is usually limited by a maximum time in which overheating still does not occur despite the high viscosity of the cooling liquid. The active time is most preferably between 5 min and 20 min, in particular between 10 min and 15 min.

In order to prevent damage to the at least one pump unit and/or to achieve the effects described above in the case of a transformer whose devices for increasing the heat exchange performance include at least one ventilator unit and at least one pump unit, in a further embodiment of the invention for the devices for increasing the heat exchange performance of the at least one heat-exchanger unit therefore comprise at least one ventilator unit and at least one pump unit which transports the cooling liquid through the at least one heat-exchanger unit in the normal operating state, where the control unit deactivates the ventilator unit and either deactivates or periodically activates and deactivates the pump unit if the lower temperature Tᵤ of the cooling liquid lies below a lower limit temperature Gᵤ, where the lower limit temperature Gᵤ is lower than the lower threshold value Sᵤ; deactivates the at least one ventilator unit and activates the at least one pump unit, preferably continuously, if the lower temperature Tᵤ of the cooling liquid lies between the lower limit temperature Gᵤ and the lower threshold value Sᵤ; and operates the at least one ventilator unit and the at least one pump unit based on the normal operating state if the lower temperature Tᵤ lies above the lower threshold value Sᵤ.

As a result of performing the method in a corresponding manner, damage to the pump units is prevented because at temperatures below the lower limit temperature Gᵤ they are either not started up at all or only started up periodically. Only when the lower temperature Tᵤ of the cooling liquid has risen above the lower limit temperature Gᵤ and therefore has a correspondingly lower viscosity does the at least one pump unit remain constantly activated in order to achieve the effects described above. If the means for increasing the heat exchange performance also comprise ventilator units, these remain deactivated for the reasons outlined above until the lower temperature Tᵤ lies above the lower threshold value Sᵤ.

The temperature-dependent viscosity of the cooling liquid has a critical role in the circulation of the cooling liquid in the cooling system. As a result, in a further embodiment, the lower threshold value Sᵤ lies in a range between 10° C. and 40° C., preferably between 20° C. and 30° C., above a congealing temperature of the cooling liquid. Here, a congealing value is understood to be that temperature of the cooling liquid at which the viscosity of the cooling liquid is so great that for a sample within a specific time period, in particular within 10 sec, no further movement of the sample occurs. The congealing point of mineral oil may be −45° C., for example, and the congealing point of biological liquids following lengthy storage under low temperatures may be approximately −25° C., for example. By applying a temperature range above this congealing value or congealing point, an undesirable cold characteristic of the cooling liquid can easily and reliably be detected and measures in accordance with disclosed embodiments of the invention can be applied correspondingly to prevent negative effects on the transformer, such as overheating of the transformer winding. If the difference between the measured lower temperature Tᵤ and the congealing value is greater than the specified temperature range, preferably exceeding the congealing value by more than 20° C., then the cooling liquid is sufficiently fluid to ensure circulation of the cooling liquid in the cooling system.

Instead of the previously cited definition relative to the congealing value, the lower threshold value Sᵤ can also be defined as a function of the dynamic viscosity of the cooling liquid. In a further embodiment variant of the invention, provision is therefore made for the lower threshold value Sᵤ to lie in a range between 10° C. and 40° C., preferably between 20° C. and 30° C., above that temperature at which the kinematic viscidity of the cooling liquid is greater than or equal to 1800 mm²/s. This value is influenced inter alia by the structural embodiment of the cooling circuit.

With respect to the above-cited temperature ranges, the cooling liquid is ideally selected from the group comprising mineral-oil-based liquids, synthetically produced oils, in particular silicone oil, synthetically produced esters, and biologically produced liquids. The choice of cooling liquid depends on the deployment location of the transformer and on the configuration or structure of the transformer.

The measurement of the lower temperature Tᵤ can also be advantageous in further application fields in addition to the cold temperature issue relating to the cooling liquids. In a further embodiment of the invention, the measurement of a current value specifies or is proportional to the current flowing through the transformer on a primary side or secondary side of the transformer, and the power of the device for increasing the heat exchange performance is increased by the control device in comparison with the normal operating state, irrespective of the measured at least one upper temperature Tₒ, if the measured current value exceeds an upper threshold value and if the lower temperature Tᵤ of the cooling liquid lies above the lower threshold value Sᵤ. As a result of determining the current value, it is possible to delay a possible build-up of heat in the transformer before this causes a significant increase of the upper temperature Tₒ or before a (preferably first) upper threshold value of the upper temperature Tₒ is exceeded, at which point increased cooling would occur in the normal operating state. The avoidance of high temperatures in the at least one transformer winding reduces the thermal aging and allows extended running time under overload conditions before a failure or shutdown occurs. As a result of checking whether the measured lower temperature Tᵤ lies above the lower threshold value Sᵤ, cold start operation is again protected. In addition to its use in the cold state, the load current can also trigger an advance cooling when used as an additional control variable, in order thereby to reduce the heating during short-time overloads or to increase the permitted duration of the overload.

It is also an objection of the invention to provide a control device for a cooling system of a transformer, preferably a power transformer, having at least one transformer winding, where the cooling system contains a cooling liquid that circulates within the cooling system during operation of the transformer, where the control device adjusts at least the power of devices for increasing the heat exchange performance of the at least one heat-exchanger unit, where the devices interact with a heat-exchanger unit, where the at least one heat-exchanger unit is configured to release heat from the cooling liquid into the surrounding atmosphere. The object cited in the introduction is achieved by virtue of the fact that the control device is connected to a first temperature sensor for measuring a lower temperature Tᵤ of the cooling liquid and that the control device is configured to perform the disclosed embodiments of the method in accordance with the invention. In particular, the control device may be based on the triggering of relays or comprise devices for executing software solutions, e.g. microprocessors, in order to compare measured values with each other and trigger adjustment procedures. It is likewise conceivable for the control device to have a storage unit in which at least the lower threshold value Sᵤ is stored.

It is also an object of the invention to provide a transformer, preferably a power transformer or reactor, comprising at least one transformer winding and possibly a transformer core, with a cooling system that contains a cooling liquid for cooling the at least one transformer winding, where the cooling system has at least one heat-exchanger unit for release of heat from the cooling liquid into the surrounding atmosphere and devices for increasing the heat exchange performance of the at least one heat-exchanger unit, where the devices interact with the heat-exchanger unit, and has a control unit for adjusting at least the power of the devices for increasing the heat exchange performance of the at least one heat-exchanger unit, where the transformer has a first temperature sensor for determining a lower temperature Tᵤ of the coolant and the control device is configured in accordance with the disclosed embodiments of the invention as described above. In particular, it is advantageous for the first temperature sensor to be arranged in the floor region of the housing of the transformer.

Lastly, it is also an object of the invention to provide a computer program product comprising instructions which cause the inventive control device to compare the measured lower temperature Tᵤ of the cooling liquid with the lower threshold value Sᵤ and to send a first control signal and/or an input/output signal to the devices for increasing the heat exchange performance of the at least one heat-exchanger unit in order to execute the method in accordance with disclosed embodiments of the invention. In this case, it should be understood the computer program product can only adjust those tasks of the control device that can be directly influenced by the devices. For example, if no pump unit is provided or if the pump unit is not activated, and therefore the circulation of the cooling liquid relies in natural convection, then the circulation of the cooling liquid can only be influenced indirectly by the control device. A control signal and/or an input/output signal can be generated by the computer program product and transmitted via any type of signal transmission, e.g., wirelessly or wire-based. In accordance with the disclosed embodiments of the method, the devices for increasing the heat exchange performance of the heat exchange unit can be activated via an input/output signal, for example, only if the measured lower temperature Tᵤ lies above the lower threshold value Sᵤ or above the predefined range over the lower threshold value Sᵤ. If the devices for increasing the heat exchange performance comprise a plurality of assemblies or units, e.g., a plurality of ventilator units and/or a plurality of pump units, then individual assemblies or units may be activated while others remain deactivated. With the power signals, the power of the devices for increasing the heat exchange performance relative to the normal operating state can be reduced or curbed if the measured lower temperature Tᵤ lies below the lower threshold value Sᵤ, or increased if the measured lower temperature Tᵤ lies above the lower threshold value Sᵤ or above the predefined range. It should also be understood the computer program product can also contain instructions that are required for adjustment of the cooling system in the normal operating state.

In according with a further embodiment of the computer program product, the computer program product t comprises instructions that cause the control device to send a second power signal and/or a second input/output signal to the at least one pump unit. If the cooling system comprises at least one pump unit, as described above, the disclosed embodiments of the method can provide for the at least one pump unit to be activated if the lower temperature Tᵤ of the cooling liquid during the operation of the transformer lies below the lower threshold value Sᵤ, but preferably above a lower limit temperature Gᵤ. Accordingly, the instructions of the computer program product can be formed to generate the second input/output signal for activating the pump unit and/or to transmit the power of the at least one pump unit during operation via the generated second control signal and via any desired type of signal transmission, e.g., wirelessly or wire-based, to the at least one pump unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In order to explain the invention further, reference is made in the following part of the description to the figures, from which further advantageous details and possible application fields of the invention can be derived. The figures are understood to be exemplary and, while exposing the character of the invention, do not restrict or even conclusively depict it in any way, in which:

FIG. 1 shows a schematic illustration of a transformer according to the invention;

FIG. 2 shows a schematic illustration of the lower temperature; and

FIG. 3 is a flowchart of the method in accordance with the invention.

### DETAILED DESCRIPTION OF THE EXEMPLARY EMBODIMENTS

FIG. 1 shows a schematic illustration of a transformer 1 in accordance with the invention, with a transformer winding 3 that is wound around a transformer core 10. The transformer winding 3 comprises at least one lower-voltage winding and at least one higher-voltage winding, which are not illustrated further in the figure. The transformer 1 can also be formed as a reactor. Moreover, the transformer winding 3, more precisely the electrical conductors thereof, can be enwound with cellulose paper for the purpose of electrical insulation.

The transformer winding 3 and the transformer core 10 are arranged in a housing 2 that is filled with a cooling liquid 7. In addition to the cooling of the transformer 1, described in greater detail below, i.e., the cooling of at least the transformer winding 3 and the transformer core 10, the cooling liquid 7 also serves to electrically insulate the transformer 1. It is therefore particularly advantageous for the cooling liquid 7 to be a cooling liquid that is suitable for transformers, e.g., a transformer oil. Use is typically made of mineral-oil-based cooling liquids in this case, though synthetic liquids based on, e.g., silicone oil or esters, or ultimately even “biological liquids” that nonetheless have raised congealing temperatures, are also viable for use in transformers.

In order to dissipate the heat that is generated in the transformer winding 3 during the operation of the transformer 1 and that increases with the electrical load of the transformer 1, a cooling system is provided in which the cooling liquid 7 circulates. In order to release the heat energy in the cooling system efficiently from the cooling liquid 7 into the environment or the surrounding atmosphere, in particular the surrounding air, the cooling system comprises at least one heat-exchanger unit 5 and devices 15 that interact with the heat-exchanger unit 5 for increasing the heat exchange performance of the at least one heat-exchanger unit 5. In the present exemplary embodiment, the heat-exchanger unit 5 is linked via a cooling circuit 4 that is connected to the housing 2. The circulation of the cooling liquid 7 through the cooling system, i.e., in particular in the interior of the housing 2 and within the cooling circuit 4, can in principle occur as a result of natural convection. It should not be forgotten that the housing 2 of the transformer 1 also functions as a heat exchanger, though no separate devices 15 for increasing the heat exchange performance are usually provided for the housing 2.

In the exemplary illustrated embodiment, the devices 15 for increasing the heat exchange performance comprise both a ventilator unit 6 via which the heat-exchanger unit 5 can be cooled, and a pump unit 11 via which the natural convection of the cooling liquid 7 in the cooling system can be assisted or a forced convection can be effected, at least through the cooling circuit 4. It should be understood the number of heat-exchanger units 5, ventilator units 6, pump units 11 and cooling circuits 4 is unlimited and is freely selectable in accordance with the specific application, where systems comprising only one or a plurality of ventilator units 6 or only one or a plurality of pump units 11 are also conceivable.

For the purpose of the heat exchange, the heat-exchanger unit 5 in the present exemplary embodiment is cooled by the surrounding air, where the surrounding air absorbs heat from the heat-exchanger unit 5 or from the cooling liquid 7 that flows through the heat-exchanger unit 5. Cooler surrounding air can be supplied to the heat-exchanger unit 5 by natural convection and/or via at least the ventilator unit 6. If the cooling of the heat-exchanger unit 5 is produced via the ventilator unit 6 (as in the presently illustrated exemplary embodiment), surrounding air is sucked in by the ventilator unit 6 and blown onto the heat-exchanger unit 5 on an outlet side 9 of the ventilator unit 6, where the outlet side 9 faces towards the radiator 5.

In order to adjust the cooling of the transformer 1 when the transformer 1 is under load and generates heat, provision is made for a control device 8 which is connected in the present exemplary embodiment to the pump unit 11, the ventilator unit 6 and to a first temperature sensor 12 and a second temperature sensor 13, at least for the purpose of information transfer, this being indicated by the broken and dash-dot lines. In conventional control devices 8, an upper temperature Tₒ of the cooling system is captured as an input variable and the required cooling power is adjusted as a function of the upper temperature Tₒ. The upper temperature Tₒ can be captured by the second temperature sensor 13, for example. In the present exemplary embodiment, the second temperature sensor 13 is configured as a sensor for hot cooling liquids, in particular a hot-oil sensor, which captures an upper temperature Tₒ of the cooling liquid 7. It is, however, also conceivable for the upper temperature Tₒ to be measured as a temperature in the transformer winding 3 or in the transformer core 10 or in the interior of a winding assembly, where combinations of different temperature measurements are also conceivable.

The devices 15 for increasing the heat exchange performance is usually driven by the control device 8 such that they are activated or their cooling power is increased when the measured upper temperature Tₒ exceeds a predefined upper temperature threshold. It should be understood it is also possible to define a plurality of upper threshold values, where each threshold value is assigned a different cooling power.

In the case of operation involving problematic cold temperatures, i.e., if the temperature of the coolant 7 is low due to low environmental temperatures, or in the case of a cold start of the transformer 1, i.e., when the transformer 1 is started up under low environmental temperatures, then the cooling liquid 7 can exhibit a particularly high viscosity due to the low environmental temperature. As a result, the ability of the cooling liquid 7 to flow through the cooling circuit 4, in particular through the heat-exchanger unit 5, is reduced in an unacceptable manner, such that the cooling power of the heat-exchanger unit 5 is unavailable and the remaining cooling power of the housing 2 of the transformer 3 is insufficient. This behavior of the cooling liquid 7 under low environmental temperatures can, as described below, result in unacceptable operating states such as high temperatures in the transformer 1.

While the cooling liquid 7 in the region of the transformer winding 3 is heated by the heat that is produced during operation, and the viscosity reduces such that part of the cooling liquid 7 circulates in the cooling system, other parts of the cooling liquid 7, which are situated in the cooling circuit 4 and in the heat-exchanger unit 5, remain undercooled and therefore prevent a flow of the cooling liquid 7 through the cooling circuit 4 and heat-exchanger unit 5. This can be explained, e.g., by the fact that these elements of the cooling system are arranged further away from the transformer winding 3 and by the fact that these elements usually have a large surface area in order to achieve a heat exchange and/or occupy an exposed position and are significantly affected by the environmental temperatures. It can therefore occur that the temperature of the cooling liquid 7 in the cooling circuit 4 and in the heat-exchanger unit 5 remains at a very low temperature level over an extended time period. If a conventional control device 8 is then used, a high upper temperature Tₒ would be measured (in the already heated cooling liquid 7, in particular in the upper region of the housing 2, or in the transformer winding 3 itself), which would trigger an additional cooling of the heat-exchanger unit 5 by the ventilator unit 6 and the pump unit 11.

However, this must be considered as disadvantageous, because the cooling liquid 7 that flows back from the heat-exchanger unit 5 and that should heat the remaining parts of the cooling liquid 7 stays at a lower temperature due to the additional cooling effected via the ventilator unit 6, such that a flow of the cooling liquid 7 through the cooling circuit 4 is not achieved as a result of the continued high viscosity of the cooling liquid 7 in the region of the heat-exchanger unit 5. In other words, the additional cooling of the cooling liquid 7 via the ventilator unit 6 can result in only part of the coolant 7 contained in the cooling system circulating in the cooling system, such that the heat cannot be dissipated efficiently and overheating of the transformer 1 can occur. It is particularly critical in this case that, due to the additional cooling, the heat-exchanger unit 5 cannot then contribute to the cooling of the circulating cooling liquid 7 and therefore the cooling circuit 4 cannot fulfill its function. The reason for this (as mentioned above) is the high viscosity of the cooling liquid 7, which has been cooled as a result of the low environmental temperature and additional cooling, in the cooling circuit 4 and in the heat-exchanger unit.

In order to overcome these disadvantages, in accordance with the present invention, a lower temperature Tᵤ of the cooling liquid 7 is measured in the cooling system and, irrespective of the measured at least one upper temperature Tₒ, the control device 8 does not activate the devices 15 for increasing the heat exchange performance or operates the devices 15 for increasing the heat exchange performance at a reduced power relative to the normal operating state if the lower temperature Tᵤ of the cooling liquid 7 lies below a lower threshold value Sᵤ during the operation of the transformer 1. For the purpose of capturing the lower temperature Tᵤ of the cooling liquid 7, the first temperature sensor 12 in the present exemplary embodiment is arranged in a floor region 14 of the housing 2. The cooling liquid 7 having the lowest temperature sinks towards the floor of the housing 2 due to the high viscosity or the high density, while the cooling liquid 7 that is heated in the region of the transformer winding 3 rises. As a result, a first temperature sensor 12 arranged in the floor region 14 is particularly suitable for capturing the lower temperature Tᵤ of the cooling liquid 7, because the lowest temperature of the cooling liquid 7 can be expected in the floor region 14.

It is advantageous in this case for the lower threshold value Sᵤ, which is dependent on the composition of the cooling liquid 7 used, to be defined in relation to the congealing point or the congealing value of the cooling liquid 7. For example, it is found to be particularly advantageous if the lower threshold value Sᵤ lies e.g. 40° C. above the congealing point. Therefore, if the measured lower temperature Tᵤ of the cooling liquid 7 lies below the lower threshold value Sᵤ, e.g., possibly more than 20° C. below the lower threshold value Sᵤ, depending on the viscosity and the hydraulic relationships (e.g. the hydraulic resistance and the buoyancy force acting against this), adequate circulation of the cooling liquid 7 in the cooling circuit 4 or through the heat-exchanger unit 5 is not possible. In this case, the control device 8 will inventively prevent any additional cooling of the cooling liquid 7 in the heat-exchanger unit 5.

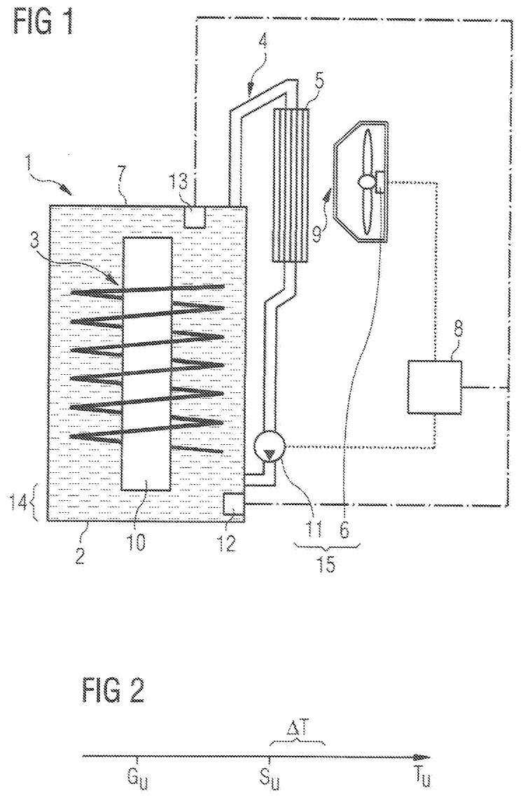

In according with the disclosed method of the invention, the additional cooling of the heat-exchanger unit 5 by the ventilator unit 6 in a cold start situation, which is detected if the measured lower temperature Tᵤ lies below the lower threshold value Sᵤ, is therefore either completely stopped or at least reduced, such that the cold cooling liquid 7 in the lower region of the housing 2 and the cooling liquid 7 in the cooling circuit 4 is more quickly brought into line with the temperature level of the already circulating cooling liquid 7, such that a viscosity of the cooling liquid 7 is obtained which allows the circulation of as far as possible all the cooling liquid 7 in the cooling system, in particular in the cooling circuit 4 and through the heat-exchanger unit 5, and functional cooling of the transformer 1 is thus achieved even when problems arise in relation to cold. As soon as the lower temperature Tᵤ reaches the lower threshold value Sᵤ or exceeds the lower threshold value Sᵤ, e.g., in a predefined transition temperature range ΔT that lies above the lower threshold value Sᵤ (see FIG. 2), the normal operating state can be reactivated by the control device 8, such that the additional cooling of the heat-exchanger unit 5 is reactivated or the power of the ventilator unit 6 is increased to a normal value and is adjusted or controlled as a function of the measured upper temperature Tₒ.

In a further embodiment of the method of the invention, the pump unit 11 is used as part of the devices 15 for increasing the heat exchange performance. The pump unit 11 contributes significantly to the transfer of heat away from the heated regions of the transformer 1 to the heat-exchanger units 5. By virtue of the heat transport and the heat that is released due to operation, the pump unit 11 can also be used to heat the cold (or even thickening) cooling liquid 7 in the region of the heat-exchanger unit 5. The pump unit 11 is also used to improve the flow situation by increasing the delivery pressure in the cooling circuit 4 in addition to the natural buoyancy factors. If a lower temperature Tᵤ of the cooling liquid 7 which lies below the lower threshold value Sᵤ is detected, then the control device 8 can control the pump unit 11 such that, by virtue of the pump unit 11, a greater volumetric flow of the insufficient throughput is effected in the cooling circuit 4 and/or in the heat-exchanger unit 5 and the cooling liquid 7 that has been heated by the transformer 1 is thus supplied to the heat-exchanger unit 5. Here, the ventilator unit 6 therefore remains deactivated because it has been detected that the lower threshold value Sᵤ has not been reached, while the pump unit 11 is activated.

In this context, reference is made briefly to FIG. 2, which depicts a schematic illustration of the relevant values of the lower temperature Tᵤ. The lower threshold value Sᵤ, at which the power of the devices 15 for increasing the heat exchange performance is inventively adapted, has already been discussed in detail. This lower threshold value Sᵤ can lie between 20° C. and 30° C. above the congealing point, for example.

The transition temperature range ΔT, whose lower limit forms the lower threshold value Sᵤ, was also cited above. In this range of generally between 20° C. and 25° C. above the lower threshold value Sᵤ, it is possible to maintain an inventive reduction of the cooling, e.g., in order to ensure a corresponding heating of the cooling liquid 7 in the cooling circuit 4 and/or in the heat-exchanger unit 5, which allows operation of the devices 15 for increasing the heat exchange performance in normal operation. It is therefore possible to make allowance for, e.g., a time delay between the increase in the measured lower temperature Tᵤ in the housing 2 and the actual heating in the complete cooling circuit 4 and/or in the heat-exchanger unit 5.

As discussed above, the operation of the pump unit 11 below the lower threshold value Sᵤ can be advantageous. However, if the temperature Tᵤ lies below a lower limit temperature Gᵤ that lies in the region of the congealing point of the cooling liquid, e.g., only up to 5° C. above the congealing point, the viscosity of the cooling liquid 7 would be so high that continuous activation of the pump unit 11, due to the insufficient cooling resulting from the reduced throughput of cooling liquid 7 through the pump unit 11, would trigger the motor protection of the pump unit 11, and therefore the pump unit would remain deactivated for an extended period of time. The control unit 8 can therefore be configured such that the pump unit 11 either remains completely deactivated or is periodically activated and deactivated, while the ventilator unit 6 remains constantly deactivated, if the lower temperature Tᵤ lies below the lower limit temperature Gᵤ. Periodical operation can be achieved, for example, by alternately activating the pump unit 11 for a first time period, such as 10 min, and then deactivating the pump unit 11 for a second time period, e.g., of equal length to the first time period. In the temperature range between the lower limit temperature Gᵤ and the lower threshold value Sᵤ, and possibly within the transition temperature range ΔT, the pump unit 11 remains activated, while the ventilator unit 6 remains deactivated or is operated at reduced power. The same naturally applies analogously for the pump unit 11 alone, if no ventilator unit 6 is present. If the lower temperature Tᵤ exceeds the lower threshold value Sᵤ or the transition temperature range ΔT, the cooling can occurs in the normal operating state again based on the upper temperature Tₒ in the context of the normal operating state.

If the cooling liquid 7 is, e.g., a mineral-oil-based cooling liquid, then the congealing temperature or the temperature at which the cooling liquid 7 exceeds a dynamic viscosity of 1800 mm²/s is approximately −45° C. The lower limit temperature Gᵤ, that is relevant for the operation of the pump unit 11 in particular, can be approximately −40° C. for exemplary purposes, while the lower threshold value Sᵤ, which is relevant for the operation of the ventilator unit 6 in particular, can be approximately −15° C. The associated transition temperature range ΔT therefore terminates at a lower temperature of approximately 10° C. Beyond this, the control occurs in the normal operating state again based on the upper temperature Tₒ.

Finally, it is also conceivable for a current value to be measured by a converter at the transformer 1, where the current value specifies or is at least proportional to the current flowing on a primary side or secondary side of the transformer 1. Various scenarios are suitable for a computer-based solution, which can also obtain the information from other regions and if necessary from the network control system. Taking the measured lower temperature Tᵤ of the cooling liquid 7 into account, it is therefore possible by including the load of the transformer 1 to achieve an advance cooling of the transformer 1 via the control device 8, if the transformer 1 is not in a situation with a critically low lower temperature Tᵤ of the cooling liquid 7 but an upper threshold value of the upper temperature Tₒ of the cooling system has not yet been reached. In other words, an additional cooling can already be effected before the actual upper threshold value of the upper temperature Tₒ is reached.

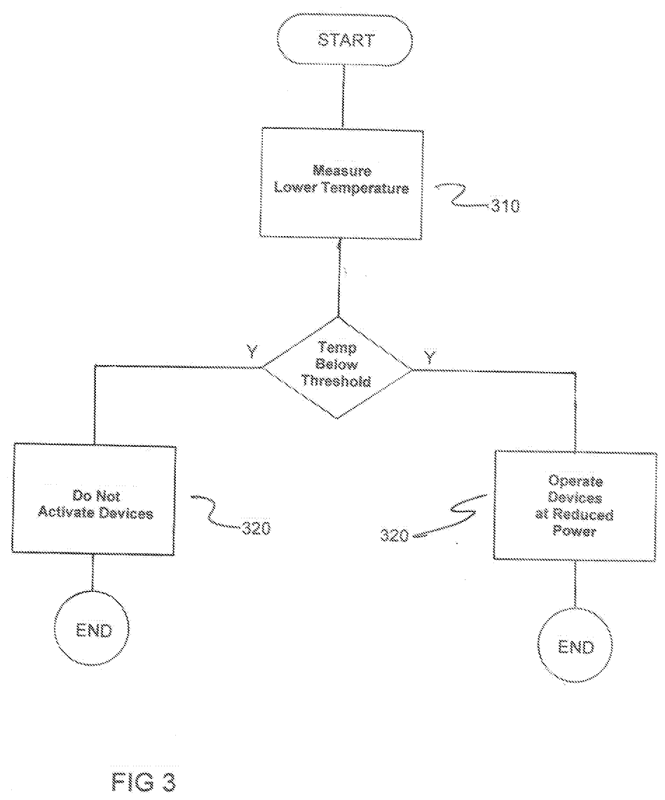

FIG. 3 is a flowchart of a method for operating a cooling system of a transformer 1 having at least one transformer winding 3, where the cooling liquid 7 of the cooling system surrounds the at least one transformer winding 3 and the cooling liquid 7 circulates in the cooling system in a normal operating state of the transformer 1, at least heat produced in the at least one transformer winding 3 is released into a surrounding atmosphere via the circulating cooling liquid 7, and where the cooling system comprises at least one heat-exchanger unit 5 through which the cooling liquid 7 can flow, for a release of heat from the cooling liquid 7 into the surrounding atmosphere, means 15 for increasing a heat exchange performance of the at least one heat-exchanger unit 5, where the means 15 interacts with the at least one heat-exchanger unit 5, a control unit 8 for adjusting the heat exchange performance of the at least one heat-exchanger unit 5, where an upper temperature Tₒ is measured in either the cooling system or at the transformer 1 and where, in a normal operating state, the control unit 8 adjusts the power of the means 15 to increase heat exchange performance of the at least one heat-exchanger unit 5 as a function of the measured upper temperature Tₒ.

The method comprises measuring a lower temperature Tᵤ of the cooling liquid 7 in the cooling system, as indicated in step 310.

Next, irrespective of the measured upper temperature Tₒ, the control unit either (i) refrains from activating the means 15 for increasing the heat exchange performance of the at least one heat-exchanger unit 5 if the lower temperature Tᵤ of the cooling liquid 7 lies below a lower threshold value Sᵤ during operation of the transformer 1 or (ii) operates the means 15 for increasing the heat exchange performance of the at least one heat-exchanger unit 5 at a reduced power relative to the normal operating state if the lower temperature Tᵤ of the cooling liquid 7 lies below a lower threshold value Sᵤ during operation of the transformer 1, as indicated in step 320.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a cooling system of a transformer having at least one transformer winding, a cooling liquid of the cooling system surrounding the at least one transformer winding and the cooling liquid circulating in the cooling system in a normal operating state of the transformer, at least heat produced in the at least one transformer winding being released into a surrounding atmosphere via the circulating cooling liquid, said cooling system comprising at least one heat-exchanger unit through which the cooling liquid can flow, for release of heat from the cooling liquid into the surrounding atmosphere, devices for increasing heat exchange performance of the at least one heat-exchanger unit, said devices interacting with the at least one heat-exchanger unit, a control unit for adjusting the heat exchange performance of the at least one heat-exchanger unit, an upper temperature being measured in at least one of (i) the cooling system and (ii) at the transformer and, in a normal operating state, the control unit adjusting a power of the devices for increasing heat exchange performance of the at least one heat-exchanger unit as a function of the measured upper temperature, the method comprising:
measuring a lower temperature of the cooling liquid in the cooling system; and
irrespective of the measured upper temperature, at least one of:
i) refraining from activating, by the control unit, the devices for increasing heat exchange performance of the at least one heat-exchanger unit if the lower temperature of the cooling liquid lies below a lower threshold value during operation of the transformer and
ii) operating, by the control unit, the device for increasing heat exchange performance of the at least one heat-exchanger unit at a reduced power relative to the normal operating state if the lower temperature of the cooling liquid lies below a lower threshold value Sᵤ during operation of the transformer.

2. The method as claimed in claim 1, wherein the devices for increasing heat exchange performance of the at least one heat-exchanger unit comprise at least one of (i) at least one ventilator unit and (ii) at least one pump unit which transports the cooling liquid through the at least one heat-exchanger unit in the normal operating state.

3. The method as claimed in claim 1, wherein the transformer is arranged inside a housing which is filled with the cooling liquid, and the heat-exchanger unit is arranged in a cooling circuit which is fluidically connected to the housing; and wherein the cooling liquid circulates through the cooling circuit in the normal operating state.

4. The method as claimed in claim 2, wherein the transformer is arranged inside a housing which is filled with the cooling liquid, and the heat-exchanger unit is arranged in a cooling circuit which is fluidically connected to the housing; and wherein the cooling liquid circulates through the cooling circuit in the normal operating state.

5. The method as claimed in one of claim 1, wherein the lower temperature of the cooling liquid is measured in that region of the cooling system in which the lowest temperature of the cooling liquid is to be expected.

6. The method as claimed in claim 1, wherein the lower temperature of the cooling liquid is measured in that region of the housing of the cooling system.

7. The method as claimed in claim 3, wherein the lower temperature is measured via a first temperature sensor; and wherein the first temperature sensor is arranged in at least one of (i) a floor region of the housing and (ii) a region of a junction of an outlet of the cooling circuit into the housing.

8. The method as claimed in claim 6, wherein the lower temperature is measured via a first temperature sensor; and wherein the first temperature sensor is arranged in at least one of (i) a floor region of the housing and (ii) a region of a junction of an outlet of the cooling circuit into the housing.

9. The method as claimed in claim 1, wherein the devices for increasing heat exchange performance of the at least one heat-exchanger unit comprises at least one pump unit which transports the cooling liquid through the at least one heat-exchanger unit in the normal operating state; and wherein the at least one pump unit is activated by the control unit if the lower temperature of the cooling liquid during the operation of the transformer lies below the lower threshold value Sᵤ and above a lower limit temperature.

10. The method as claimed in claim 1, wherein the devices for increasing heat exchange performance of the at least one heat-exchanger unit comprise at least one pump unit which transports the cooling liquid through the at least one heat-exchange unit in the normal operating state; and wherein the at least one pump unit is periodically activated and deactivated by the control unit if the lower temperature of the cooling liquid during the operation of the transformer lies below a lower limit temperature, which lower limit temperature is lower than the lower threshold value.

11. The method as claimed in claim 1, wherein the devices for increasing heat exchange performance of the at least one heat-exchanger unit comprise at least one ventilator unit and at least one pump unit which transports the cooling liquid through the at least one heat-exchanger unit in the normal operating state; and
wherein the control unit:
deactivates the at least one ventilator unit and one of (i) deactivates and (ii) periodically activates and deactivates the at least one pump unit if the lower temperature of the cooling liquid lies below a lower limit temperature, said lower limit temperature being lower than the lower threshold value;
deactivates the at least one ventilator unit and activates the at least one pump unit if the lower temperature of the cooling liquid lies between the lower limit temperature and the lower threshold value; and
operates the at least one ventilator unit and the at least one pump unit based on the normal operating state if the lower temperature lies above the lower threshold value.

12. The method as claimed in claim 1, wherein the lower threshold value lies in a range between 10° C. and 40° C. above a congealing temperature of the cooling liquid.

13. The method as claimed in claim 12, wherein the lower threshold value lies between 20° C. and 30° C.

14. The method as claimed in claim 1, wherein the lower threshold value lies in a range between 10° C. and 40° C. above that temperature at which the kinematic viscidity of the cooling liquid is greater than or equal to 1800 mm²/s.

15. The method as claimed in claim 1, wherein the lower threshold value lies in a range between 20° C. and 30° C.

16. The method as claimed in claim 1, wherein the cooling liquid is selected from the group comprising mineral-oil-based liquids, synthetically produced oils comprising silicone oil, synthetically produced esters, and biologically produced liquids.

17. The method as claimed in claim 1, further comprising:
measuring a current value, which specifies or is proportional to the current flowing through the transformer on a primary side or secondary side of the transformer; and
increasing the power of the devices for increasing heat exchange performance by the control device in comparison with the normal operating state, irrespective of the measured at least one upper temperature, if the measured current value exceeds an upper threshold value and if the lower temperature of the cooling liquid lies above the lower threshold value.

18. The method as claimed in claim 1, wherein the transformer comprises one of a power transformer and a reactor.

19. A control device for a cooling system of a transformer having at least one transformer winding, the cooling system containing a cooling liquid \ which circulates within the cooling system during operation of the at least one transformer;
wherein the control device adjusts at least a power of devices for increasing heat exchange performance of at least one heat-exchanger unit, said devices interacting with the at least one heat-exchanger unit;
wherein the at least one heat-exchanger unit is configured to release heat from the cooling liquid into the surrounding atmosphere,
wherein the control device is connected to a first temperature sensor (12) for measuring a lower temperature of the cooling liquid; and
wherein the control device is configured to:
measure a lower temperature of the cooling liquid in the cooling system; and
irrespective of the measured upper temperature, at least one of:
(i) refrain from activating the devices for increasing heat exchange performance of the at least one heat-exchanger unit if the lower temperature of the cooling liquid lies below a lower threshold value during operation of the transformer and
(ii) operate the devices for increasing heat exchange performance of the at least one heat-exchanger unit at a reduced power relative to the normal operating state if the lower temperature of the cooling liquid lies below a lower threshold value Sᵤ during operation of the transformer.

20. The control device as claimed in claim 19, wherein the transformer comprises one of a power transformer and a reactor.

21. A transformer comprising:
at least one transformer winding; and
a first temperature sensor for determining a lower temperature of a coolant;
a cooling system containing the cooling liquid for cooling the at least one transformer winding;
wherein the cooling system includes:
at least one heat-exchanger unit for release of heat from the cooling liquid into a surrounding atmosphere;
devices for increasing heat exchange performance of the at least one heat-exchanger unit, said devices interacting with the at least one heat-exchanger unit; and
a control unit for adjusting at least the power of the devices for increasing heat exchange performance of the at least one heat-exchanger unit;
wherein the control device is configured as claimed in claim 13.

22. The transformer as claimed in claim 21, wherein the transformer comprises one of (i) a power transformer and (ii) reactor.

23. A non-transitory computer-readable medium encoded with instructions which, when executed by a processor, cause the control device to compare a measured lower temperature of the cooling liquid with a lower threshold value and to send at least one of (i) control signals and (ii) input/output signals to devices for increasing heat exchange performance of at least one heat-exchanger unit, the instructions comprising:
program code for, measuring a lower temperature of the cooling liquid in the cooling system; and
program code for, irrespective of the measured upper temperature, at least one of:
i) refraining from activating, by the control unit, the devices for increasing heat exchange performance of the at least one heat-exchanger unit if the lower temperature of the cooling liquid lies below a lower threshold value during operation of the transformer and
ii) operating, by the control unit, the devices for increasing heat exchange performance of the at least one heat-exchanger unit at a reduced power relative to the normal operating state if the lower temperature of the cooling liquid lies below a lower threshold value during operation of the transformer.
